(19) United States
(12) Patent Application Publication
(10) Pub. No.: US 2024/0030830 A1
(43) Pub. Date: Jan. 25, 2024

(54) AC/DC CONVERTER AND CONTROL METHOD THEREOF FOR CHARGING ELECTRICAL VEHICLES

(71) Applicants: HUAWEI TECHNOLOGIES CO., LTD., Shenzhen (CN); FRAUNHOFER-GESELLSCHAFT ZUR FÖRDERUNG DER ANGEWANDTEN FORSCHUNG E.V., Munich (DE)

(72) Inventors: Haitao Chen, Shenzhen (CN); Zhixiang Hu, Dongguan (CN); Xingzhong Zhang, Dongguan (CN); Peng Shuai, Shenzhen (CN); Eckart Hoene, Berlin (DE)

(21) Appl. No.: 18/477,250

(22) Filed: Sep. 28, 2023

Related U.S. Application Data
(63) Continuation of application No. PCT/EP2021/058128, filed on Mar. 29, 2021.

(51) Int. Cl. H02M 7/219; H02M 3/335; B60L 53/22

(52) U.S. Cl. CPC H02M 7/219; H02M 3/33573; B60L 53/22; H02J 2310/48; H02J 9/06

(57) ABSTRACT

The present disclosure refers to an alternating current/direct current (AC/DC) converter for an on board charger (OBC). The AC/DC converter includes a three-phase-input comprising three inputs, a single-stage dual-active bridge (DAB) circuit, and an auxiliary circuit. The auxiliary circuit includes two switching means and an energy storage means, the auxiliary circuit also includes at least two branches, wherein each of the at least two branches include one of the switching means. At least one branch of the at least two branches is connected to a single-phase AC input of the three inputs, and another branch of the at least two branches is connected to an input of the three inputs which is not a single-phase AC input, and the another branch comprises the energy storage means.

### CROSS-REFERENCE TO RELATED APPLICATIONS

This application is a continuation of International Application No. PCT/EP2021/058128, filed on Mar. 29, 2021, the disclosure of which is hereby incorporated by reference in its entirety.

### FIELD

The present disclosure refers to the technical field of alternating current/direct current (AC/DC) converter technology suitable for charging electrical vehicles (EV).

In this regard, the present disclosure refers to an AC/DC converter for an on board charger (OBC).

The present disclosure also refers to an OBC for an electrical vehicle, a charging station for an electrical vehicle, and an uninterruptible power supply (UPS) system.

Furthermore, the present disclosure refers to an AC/DC power supply.

### BACKGROUND

Vehicle electrification is being promoted by many local and national governments in responding to the urgent need for reducing fossil fuel consumption and emissions of carbon dioxide and other green-house gases and harmful particulates from the transportation sector. To help accelerate the acceptance of EVs, low-cost, high power density OBCs are highly desirable. In addition, chargers with bi-directional power flow capability can enhance the functionality and value of the vehicles by providing additional capabilities.

In addition, more and more people hope to reduce the charging time of electric vehicles, which means that the charging power of OBC will become larger and larger, and the high-power OBC requires three-phase AC input. For places without three-phase power distribution, It also may be necessary to be able to charge with a single AC input, so the OBC needs to be compatible with three-phase and single-phase inputs.

### SUMMARY

In view of the above-mentioned problems and disadvantages, the present disclosure aims to improve the current implementations.

The present disclosure provides improved AC/DC conversion. In an embodiment, the present disclosure provides a more simplified AC/DC conversion, which is compatible with three-phase and single-phase inputs.

According to an aspect of the disclosure, an alternating current/direct current (AC/DC) converter for an on board charger (OBC) is provided. The AC/DC converter comprises a three-phase-input comprising three inputs; a single-stage dual-active bridge (DAB) circuit; and an auxiliary circuit. The auxiliary circuit comprises two switching means and energy storage means, wherein the auxiliary circuit comprises at least two branches, wherein two branches each comprise one of the switching means, wherein at least one branch is connected to an input which is a single-phase AC input, wherein another branch is connected to an input which is not a single-phase AC input, and wherein the other branch comprises the energy storage means.

In other words, the auxiliary circuit, at least, comprises two branches. One of the branches is connected to an input which is used as a three-phase input. Another of the branches is connected to an input which is used as a single-phase input. One of the branches at least comprises the energy storage means and one of the switching means. The other branch comprises only one of the switching means.

The AC/DC converter may be suitable for an OBC, a charging station for an electrical vehicle, an uninterruptible power supply (UPS), or an AC/DC power supply.

According to another aspect of the disclosure, an OBC for an electrical vehicle is provided. The OBC comprises the AC/DC converter. The AC/DC converter may be modified according to any one of the optional embodiments described below.

According to another aspect of the disclosure, a charging station for an electrical vehicle is provided. The charging station comprises the AC/DC converter. The AC/DC converter may be modified according to any one of the optional embodiments described below.

According to another aspect of the disclosure, a UPS system, comprising the AC/DC converter, is provided The AC/DC converter may be modified according to any one of the optional embodiments described below.

According to another aspect of the disclosure, AC/DC power supply, comprising the AC/DC converter, is provided. The AC/DC converter may be modified according to any one of the optional embodiments described below.

According to another aspect of the disclosure, a control method for an AC/DC converter is provided. The control method may be carried out for an AC/DC converter in an OBC, in a charging station for an electrical vehicle, in a UPS, or in an AC/DC power supply.

The AC/DC converter comprises a three-phase-input comprising three inputs; a single-stage dual-active bridge (DAB) circuit; and an auxiliary circuit with at least two branches, comprising two switching means and energy storage means. Alternatively or additionally the AC/DC converter is configured and constructed according to an aspect of the disclosure. The AC/DC converter may be modified according to any one of the optional embodiments described below.

The method comprises different method steps, which are carried out depending on the connected input(s) and depending on a switching state of the electrical circuit of the AC/DC converter:

The method comprises,
in case of three-phase AC input,
   operating the auxiliary circuit such that the energy storage means does not participate in the operation of the circuit, and the switching means remain(s) disconnected.

The method comprises,
when an input voltage at the inputs is converted to a single-phase AC input for the single-stage DAB circuit, and
when the input voltage is at a higher level,
   operating the auxiliary circuit such that a remaining circuit of the single DAB circuit connected to the energy storage means operates in a BUCK state, and the energy is stored in the energy storage means.

The method comprises,
when an input voltage at the inputs is converted to a single-phase AC input for the single-stage DAB circuit, and
when the input voltage changes from a higher level to a lower level,
   operating the auxiliary circuit such that the remaining circuit of the single-stage DAB connected to the energy storage means operates in a BOOST state, and the energy storage means replenishes a bus of the single-stage DAB; and operating the auxiliary circuit such that, when input AC voltage crosses zero, the switching means switch to a working state.

The method may comprise method steps according to features of any of the optional embodiments of the AC/DC converter.

The disclosure provides a solution for compatibility of an AC/DC converter for single-phase input and three-phase input that can be realized with few components. Especially, the disclosure provides a less complex solution for an AC/DC-converter for on-board-chargers, which is less prone to unwanted artefacts, such as unwanted oscillations. Furthermore, due to a low complexity, lower maintenance effort may be necessary.

The switching means provide that in the single-phase input mode, the capacitor is always connected to the input which is not used for the three-phase input mode. Thereby, the connected capacitor, which is only used in the single-phase input mode, is charged with a potential by the auxiliary circuit in the single-phase-input mode.

Furthermore, the disclosure provides that despite of bus voltage ripple at large single-phase AC input, a larger capacitor is not required. Furthermore, inductance and bidirectional switching means, such as a bidirectional switch tube, can be used to obtain a single-stage AC input compatibility.

By the provided solution, it can be achieved a higher power density with lower cost, while packaging of the AC/DC converter is facilitated. Furthermore, the disclosure provides a better tailored and more efficient solution for power converters in electrical vehicle (EV) applications compared to the prior art.

The solution provides an AC/DC converter for a cost-reduced, high power density OBC. The on board charger provides bi-directional power flow capability which can enhance the functionality and value of electrical vehicles by providing additional charging capabilities.

Furthermore, the improved AC/DC converter, being compatible with single-phase and three-phase inputs, allows reducing the charging time for electric vehicles. Furthermore, the OBC can also be used at places without three-phase power distribution, in which one is able to charge with a single AC input.

Optionally, the auxiliary circuit may comprise three branches. Two branches each may be connected to the input which is the single-phase AC input, and the other branch, with the energy storage means, may be connected to the input which is not the single-phase AC input. An auxiliary circuit with three connections can achieve a more even load on the modules of the DAB with regard to the voltage phase at the single-phase inputs. This in turn means that the components suffer less, making the entire AC/DC converter less maintenance-intensive.

Optionally, the auxiliary circuit may be configured and connected with two or three branches to the inputs such that in case of three-phase AC input, the energy storage means does not participate in the operation of the circuit, and the switching means remain(s) disconnected. This feature provides that the auxiliary circuit does not operate in three-phase input mode. In other words, in the three-phase input mode the DAB behaves as if the auxiliary circuit was not connected at all. This has the advantage that in a three-phase input mode no additional load or even less likely artifacts such as unwanted vibrations can occur.

Optionally, the auxiliary circuit may be configured and connected with two or three branches to the inputs such that
when an input voltage at the inputs is converted to a single-phase AC input for the single-stage DAB circuit, and
when the input voltage is at a higher level,
   a remaining circuit of the single DAB circuit connected to the energy storage means operates in a BUCK state, and the energy is stored in the energy storage means. This especially refers to a high voltage scenario. In this case, the remaining circuit operates like an equivalent BUCK. This is a circuit that can implement a voltage reduction function, but the circuit cannot be simply equivalent to a buck circuit. For the previously mentioned single-stage DAB topology, a bus capacitance is not necessary when the three-phase input is used. Instead, the storage capacitor is used to store energy.

Optionally, the auxiliary circuit may be configured and connected with two or three branches to the inputs such that
when an input voltage at the inputs is converted to a single-phase AC input for the single-stage DAB circuit, and
when the input voltage changes from a higher level to a lower level,
   a remaining circuit of the single-stage DAB connected to the energy storage means operates in a BOOST state, and the energy storage means replenishes a bus of the single-stage DAB. This refers to a low voltage scenario. In this case, the remaining circuit works like an equivalent BOOST. In other words, in a second phase, when the voltage drops or is at a lower level, the DAB is fed from the capacitor. Thus, the DAB can always operate as if it was fed by a three-phase input.

Optionally, the auxiliary circuit may be configured and connected with two or three branches to the inputs such that when input AC voltage crosses zero, the switching means switch to a working state. This refers to a zero crossing scenario of the voltage. Due to the periodicity of the single-phase input mode voltage a regular switching of the switches and therefore a regular charging and discharging of the capacitor can be guaranteed. A capacitor capacity would then be selected according to an expected voltage load.

Optionally, each of the switching means and the energy storage means may be connected in parallel. Such a design is especially provided if there are three branches. In combination with the use of three branches, such a design improves that the components of the DAB are used more evenly.

Optionally, a first switching means and the storage means may be connected in series, and a second switching means may be connected in parallel with the first switching means and the storage means. It is possible that the energy storage means comprises multiple capacitors. The energy can be stored in the capacitor. When the input voltage decreases, the capacitor can release the energy. The optional embodiment may be applied for two branches or it may be applied for three branches. In case of three branches, there may be used two capacitors—such as a first capacitor which is always connected to the input used for the three-phase mode and another capacitor which is—depending on the voltage phase—connected to the input used for single-phase and three-phase mode. In case of single-phase input modes with voltage curves with strong rise/fall and with very large voltage peaks, it may be useful to use an auxiliary circuit with two branches and a capacitor with a high selected capacitance corresponding to the voltage peaks.

Optionally, the switching means may be a switch tube; and/or the energy storing means may be a capacitor. The inductance and the bidirectional switch tube in the original circuit can be used to achieve single-stage AC input compatibility. Use of switch tube and capacitor have the advantage that they are robust and low-maintenance components.

Optionally, the auxiliary circuit used for the method may comprise features of at least one of the previously described optional embodiments.

These and other aspects of the disclosure will be apparent from and elucidated with reference to the implementation forms described hereinafter. Individual features disclosed in the implementation forms can constitute alone or in combination an aspect of the present disclosure. Features of the different implementation forms can be carried over from one implementation form to another implementation form.

### BRIEF DESCRIPTION OF DRAWINGS

The above described aspects and implementation forms of the present disclosure will be explained in the following description of specific embodiments in relation to the enclosed drawings, in which

FIG. 1 schematically shows a simplified AC/DC converter circuit according to an embodiment;

FIG. 2 schematically shows a simplified AC/DC converter circuit according to the embodiment of FIG. 1, a voltage curve diagram and current flow in a first voltage phase marked in the voltage curve diagram;

FIG. 3 schematically shows the simplified AC/DC converter circuit according to the embodiment of FIG. 1, a voltage curve diagram and current flow in a second voltage phase marked in the voltage curve diagram;

FIG. 4 schematically shows a simplified AC/DC converter circuit according to another embodiment and a voltage curve diagram, wherein a first voltage phase is marked in the voltage curve diagram;

FIG. 5 schematically shows the simplified AC/DC converter circuit according to the other embodiment and a voltage curve diagram, wherein a second voltage phase is marked in the voltage curve diagram; and

FIG. 6 shows a flow diagram of a control method according to an embodiment.

### DETAILED DESCRIPTION

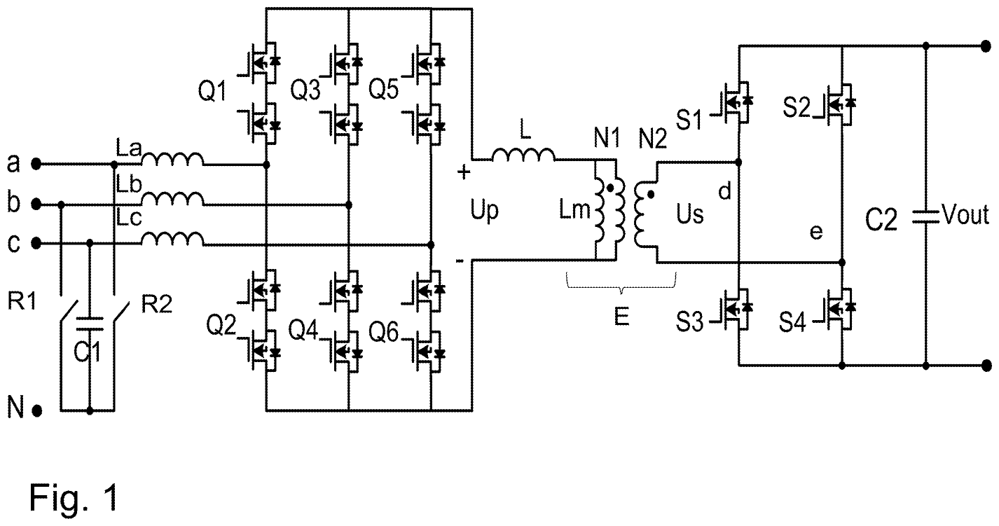

FIG. 1 schematically shows a simplified AC/DC converter circuit according to an embodiment. The AC/DC converter circuit is suitable for a three-phase input mode and for a single-phase-input mode. In accordance with the three-phase input mode capability, the circuit provides three inputs a, b, c and for the single-phase input mode capability, the inputs a and b of the circuit can be used.

The circuit comprises the three inputs a, b, c. The inputs a, b, c are connected to a single-stage dual-active-bridge (DAB) circuit. The DAB circuit comprises energy transfer means E. On one side of the energy transfer means E, which is the side of the inputs a, b, c, a voltage Up is applied. On another side of the energy transfer means E, a voltage Us is applied. On one side of the energy transfer means E multiple switching means Q1 to Q6 and an inductive element L, and on another side of the energy transfer means E multiple switching means S1 to S4 and energy storage means C2, which is a capacitor in the exemplary embodiment, are provided. The output of the DAB circuit is the output voltage Vout, to which the energy transfer means E is connected via output lines d, e. Each access of the DAB circuit is connected via an inductive element La, Lb, Lc to a respective input a, b, c.

In addition to the DAB circuit, the circuit of the AC/DC converter comprises an auxiliary circuit. The auxiliary circuit comprises two switching means R1, R2 and energy storage means C1, which is a capacitor in the exemplary embodiment. The auxiliary circuit comprises three branches.

Two branches each comprise one of the switching means R1, R2. The switching means R1, R2 are switch tubes in the exemplary embodiment. A third branch comprises the energy storage means C1. The two branches with the switching means R1, R2 are respectively connected to one of the inputs a, b which each are used as a single-phase AC input. The third branch with the energy storage means C1 is connected to an input c which is not a single-phase AC input. This input c is used in a three-phase mode.

The operating mode of the AC/DC converter depends on the voltage phase as well as on operation in the single-phase mode, i.e. the use of both inputs a, b, or operation in the three-phase mode, i.e. the use of all three inputs a, b, c. The operating modes will be explained with regard to FIGS. 1 to 3.

In case of a three-phase alternating current (AC) input, that means the use of all three inputs a, c, b, the switch tubes are disconnected to the inputs a and b. Thus, the energy storage means C1 is not connected to any circuit.

In case of a single-phase AC input, that means the use of the inputs a and b, the single-phase AC is connected to a and b terminals.

When a potential at the input a is higher than a potential at the input b, switching means R1 is closed and switching means R2 is open. In this voltage phase, C1 is connected to inputs b and c. When a potential at the input b is higher than a potential at the input a, switching means R2 is closed and switching means R1 is open. In this voltage phase, C1 is connected to inputs a and c.

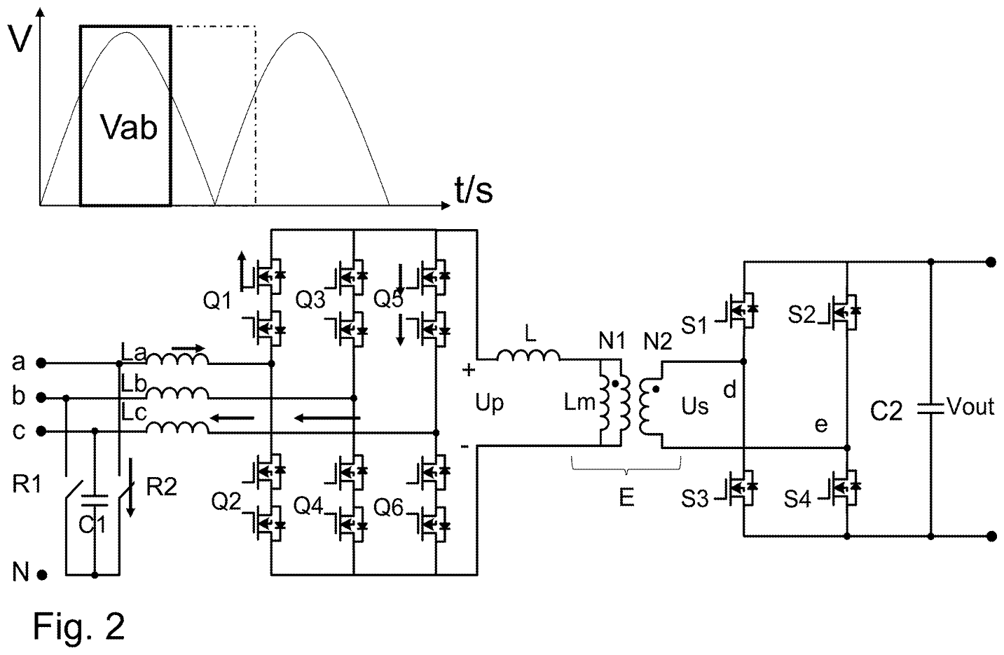

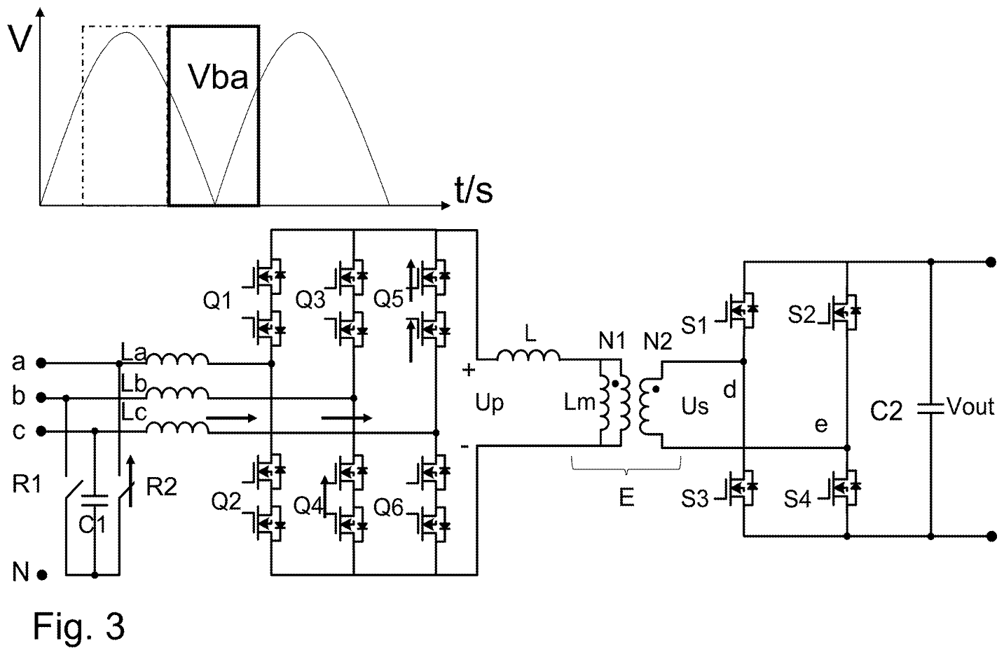

FIG. 2 schematically shows a simplified AC/DC converter circuit according to the embodiment of FIG. 1, a voltage curve diagram and current flow in a first voltage phase marked in the voltage curve diagram and FIG. 3 schematically shows the simplified AC/DC converter circuit according to the embodiment of FIG. 1, a voltage curve diagram and current flow in a second voltage phase marked in the voltage curve diagram. The two Figures show the case when a potential at the input b is higher than a potential at the input a, and the switching means R2 is closed and switching means R1 is open. In this voltage phase, C1 is connected to inputs a and c.

The switching phase of R2 being closed, and potential at the input a being higher than the potential at the input b corresponds to the voltage phase indicated by the reference letter “Vab” in the voltage curve diagram plotted against time t/s, shown above the circuit in FIG. 2. In this voltage phase, the energy storage means C1 is connected to inputs a and c.

When Vab is high, the switching means Q5, Q6 and Q4 operate and the energy is stored in the energy storage means C1 (see current flow in the circuit indicated by the drawn-through arrows in FIG. 2).

In the switching phase of R2 being closed and Vba being low (see voltage phase indicated by the reference letter “Vba” in the voltage curve diagram plotted against time t/s, shown above the circuit in FIG. 3), the energy stored in the energy storage means C1 is transmitted to a main power loop through a and c terminals corresponding to inputs a and c (see current flow in the circuit indicated by the drawn-through arrows in FIG. 3).

Similar to the case described above, the AC/DC converter circuit operates in case that the switching means R1 is closed and the switching means R2 is open: when Vab is high, the energy is stored in the energy storage means C1. When the Vba is low, the energy stored in the energy storage means C1 is transmitted to a main power loop through the b and c inputs.

In case of a single-phase AC input the switching means R1 and R2 switch their state when the AC voltage crosses zero (see the voltage curve diagrams plotted against time t/s in FIGS. 2 and 3).

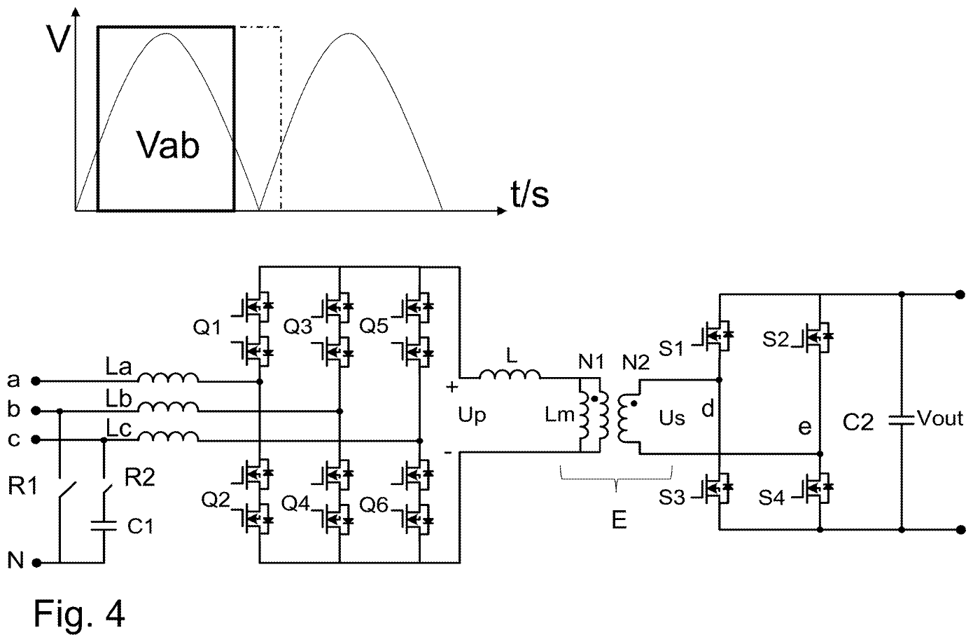

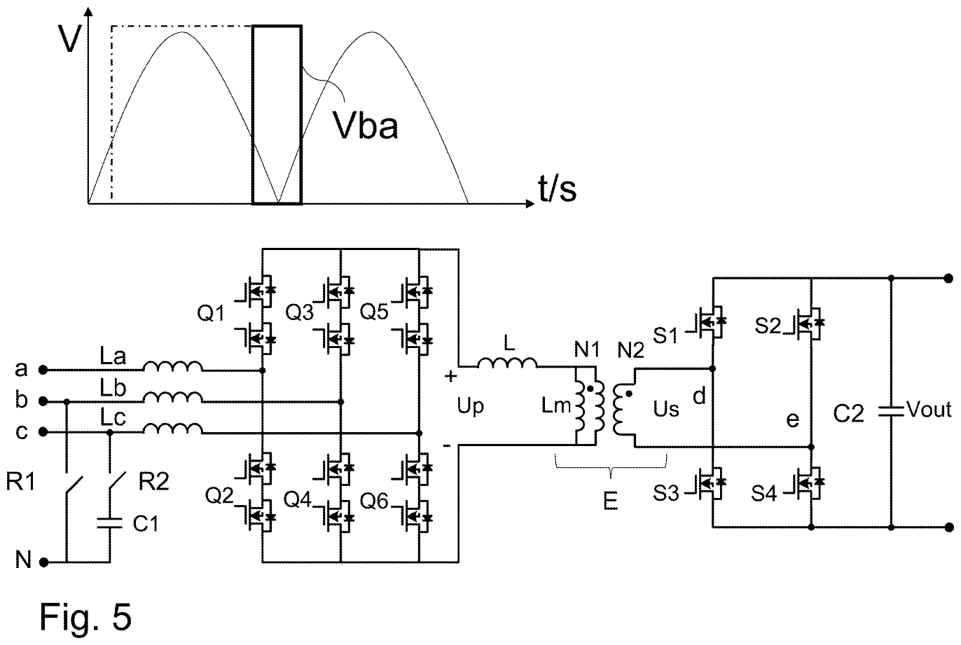

FIG. 4 schematically shows a simplified AC/DC converter circuit according to another embodiment and a voltage curve diagram, wherein a first voltage phase is marked in the voltage curve diagram and FIG. 5 schematically shows the simplified AC/DC converter circuit according to the other embodiment and a voltage curve diagram, wherein a second voltage phase is marked in the voltage curve diagram.

The circuit is similar to the circuit according to the first embodiment. The auxiliary circuit of the second embodiment is different from the auxiliary circuit of the first embodiment. The auxiliary circuit comprises two switching means R1, R2 and energy storage means C1. Furthermore, the auxiliary circuit comprises two branches. One of the branches comprises the switching means R1 and the other of the two branches comprises the energy storage means C1 and one of the switching means R2. The branch with the switching means R1 is connected to an input b which is a single-phase AC input. The other branch is connected to an input c which is not a single-phase AC input. The input c is the three-phase AC input. The branch comprising the switching means R1 is further connected to ground N.

The circuit according to the embodiment of FIG. 4 has a similar functioning as the circuit according to the embodiment of FIGS. 1 to 3. As can be seen in the voltage curve diagrams plotted against time t/s of FIGS. 4 and 5, the voltage phases, in which the circuit operates, differ from the voltage phases shown in the voltage curve diagrams of FIGS. 2 and 3. While the voltage phases for the circuit of the first embodiment according to FIGS. 1 to 3 have circuit phases equally distributed over time, i.e. both switching means R1, R2 operate over an equal time interval, the voltage phases for the circuit of the second embodiment according to FIGS. 4 and 5 have circuit phases unequally distributed over time, i.e. the first switching means R1 operates over a different time interval than the second switching means R2. Especially, the first switching means R1 operates in the voltage interval indicated by the reference letter “Vab” and the second switching means R2 operates in the shorter voltage interval indicated by the reference letter “Vba”.

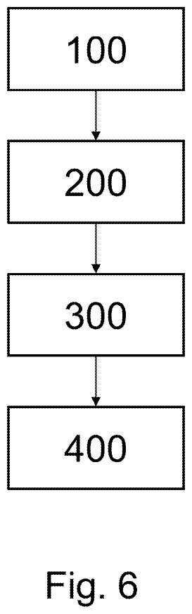

FIG. 6 shows a flow diagram of a control method according to an embodiment. The method is a control method for an AC/DC converter. The AC/DC converter may be configured and constructed according to any of the previously described embodiments. The AC/DC converter, at least, comprises a three-phase-input comprising three inputs a, b, c; a single-stage dual-active bridge (DAB) circuit; and an auxiliary circuit with at least two branches, comprising two switching means R1, R2 and energy storage means C1.

According to a step indicated by the reference number “100”, the method comprises, in case of three-phase AC input, operating the auxiliary circuit such that the energy storage means C1 does not participate in the operation of the circuit, and the switching means R1, R2 remain(s) disconnected.

According to a step indicated by the reference number “200”, the method comprises, when an input voltage at the inputs a, b, c is converted to a single-phase AC input for the single-stage DAB circuit, and when the input voltage is at a higher level,

operating the auxiliary circuit such that a remaining circuit of the single DAB circuit connected to the energy storage means C1 operates in a BUCK state, and the energy is stored in the energy storage means C1.

According to a step indicated by the reference number “300”, the method comprises, when an input voltage at the inputs a, b, c is converted to a single-phase AC input for the single-stage DAB circuit, and when the input voltage changes from a higher level to a lower level, operating the auxiliary circuit such that the remaining circuit of the single-stage DAB connected to the energy storage means C1 operates in a BOOST state, and the energy storage means C1 replenishes a bus of the single-stage DAB.

According to a step indicated by the reference number “400”, the method comprises operating the auxiliary circuit such that, when input AC voltage crosses zero, the switching means R1, R2 switch to a working state.

The disclosure has been described in conjunction with various implementations herein.

However, other variations to the disclosed implementation forms can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

### REFERENCE SIGNS LIST

a, b, c input
d, e output line
E energy transfer means
L inductive means
N ground
C1 energy storage means
C2 energy storage means
N1 component of energy transfer means
N2 component of energy transfer means
R1 switching means
R2 switching means
S1-S4 switching means
Q1-Q6 switching means
Lm component of energy transfer means
Vab voltage phase
Vba voltage phase
Vout output voltage
100 operating the auxiliary circuit such that the energy storage means does not participate in the operation of the circuit, and the switching means remain(s) disconnected
200 when an input voltage at the inputs is converted to a single-phase AC input for the single-stage DAB circuit, and when the input voltage is at a higher level, operating the auxiliary circuit such that a remaining circuit of the single DAB circuit connected to the energy storage means operates in a BUCK state, and the energy is stored in the energy storage means
300 when an input voltage at the inputs is converted to a single-phase AC input for the single-stage DAB circuit, and when the input voltage changes from a higher level to a lower level, operating the auxiliary circuit such that the remaining circuit of the single-stage DAB connected to the energy storage means operates in a BOOST state, and the energy storage means replenishes a bus of the single-stage DAB
400 operating the auxiliary circuit such that, when input AC voltage crosses zero, the switching means switch to a working state

What is claimed is:

1. An alternating current/direct current (AC/DC), converter for an on board charger (OBC) the AC/DC converter comprising:
a three-phase-input comprising three inputs;
a single-stage dual-active bridge (DAB) circuit; and
an auxiliary circuit, wherein the auxiliary circuit comprises two switching means and energy storage means, wherein the auxiliary circuit comprises at least two branches, wherein each of the at least two branches comprise one of the two switching means, wherein at least one branch of the at least two branches is connected to a single-phase AC input of the three inputs, wherein another branch of the at least two branches is connected to an input of the three inputs which is not a single-phase AC input, and wherein the another branch comprises the energy storage means.

2. The AC/DC converter according to claim 1,
wherein the auxiliary circuit comprises three branches,
wherein two branches of the three branches are connected to the single-phase AC input of the three inputs, and wherein the another branch, with the energy storage means, is connected to the input which is not the single-phase AC input.

3. The AC/DC converter according to claim 1,
wherein the auxiliary circuit is configured and connected with two or three branches to the three inputs such that in case of three-phase AC input, the energy storage means does not participate in the operation of the circuit, and the switching means remain disconnected.

4. The AC/DC converter according to claim 1,
wherein the auxiliary circuit is configured and connected with two or three branches to the three inputs such that
based on determining that an input voltage at the three inputs is converted to a single-phase AC input for a single-stage DAB circuit, and
based on determining that the input voltage is at a higher level,
a remaining circuit of the single DAB circuit connected to the energy storage means operates in a BUCK state, and energy is stored in the energy storage means.

5. The AC/DC converter according to claim 1,
wherein the auxiliary circuit is configured and connected with two or three branches to the three inputs such that
based on determining that an input voltage at the three inputs is converted to a single-phase AC input for a single-stage DAB circuit, and
based on determining that the input voltage changes from a higher level to a lower level,
a remaining circuit of the single-stage DAB connected to the energy storage means operates in a BOOST state, and the energy storage means replenishes a bus of the single-stage DAB.

6. The AC/DC converter according to claim 1,
wherein the auxiliary circuit is configured and connected with two or three branches to the three inputs such that when input AC voltage crosses zero, the two switching means switch to a working state.

7. The AC/DC converter according to claim 1,
wherein each of the two switching means and the energy storage means are connected in parallel.

8. The AC/DC converter according to claim 1,
wherein a first switching means of the two switching means and the energy storage means are connected in series, and
wherein a second switching means of the two switching means is connected in parallel with the first switching means and the energy storage means.

9. The AC/DC converter according to claim 1,
wherein each of the two switching means is a switch tube; and/or
wherein the energy storing means is a capacitor.

10. An OBC for an electrical vehicle, or a charging station for an electrical vehicle, or an uninterruptible power supply system, or an AC/DC power supply,
comprising the AC/DC converter according to claim 1.

11. A control method for an AC/DC converter,
the AC/DC converter comprising:
a three-phase-input comprising three inputs;
a single-stage dual-active bridge (DAB) circuit; and
an auxiliary circuit with at least two branches, comprising two switching means and energy storage means, wherein each of the at least two branches comprise one of the two switching means, wherein at least one branch of the at least two branches is connected to a single-phase AC input of the three inputs, wherein another branch of the at least two branches is connected to an input of the three inputs which is not a single-phase AC input, and wherein the another branch comprises the energy storage means;
the method comprising:
in case of three-phase AC input,
operating the auxiliary circuit such that the energy storage means does not participate in the operation of the circuit, and the switching means remain disconnected;
based on determining that an input voltage at the three inputs is converted to a single-phase AC input for the single-stage DAB circuit, and
based on determining that the input voltage is at a higher level,
operating the auxiliary circuit such that a remaining circuit of the single DAB circuit connected to the energy storage means operates in a BUCK state, and energy is stored in the energy storage means;
when an input voltage at the three inputs is converted to a single-phase AC input for the single-stage DAB circuit, and
based on determining that the input voltage changes from a higher level to a lower level,
operating the auxiliary circuit such that the remaining circuit of the single-stage DAB connected to the energy storage means operates in a BOOST state, and the energy storage means replenishes a bus of the single-stage DAB; and
operating the auxiliary circuit such that, when input AC voltage crosses zero, the two switching means switch to a working state.
